(19) United States
(12) Patent Application Publication
(10) Pub. No.: US 2026/0084722 A1
(43) Pub. Date: Mar. 26, 2026

(54) SERVER APPARATUS

(71) Applicant: SUBARU CORPORATION, Tokyo (JP)

(72) Inventors: Tomoyuki KITAMURA, Tokyo (JP); Yusuke OTSUKA, Tokyo (JP); Keita NAKAHASHI, Tokyo (JP); Takayuki KANEDA, Tokyo (JP)

(21) Appl. No.: 19/408,894

(22) Filed: Dec. 4, 2025

Related U.S. Application Data
(63) Continuation of application No. PCT/JP2023/024364, filed on Jun. 30, 2023.

(51) Int. Cl. B60W 60/00; B60L 53/30; B60L 53/36; B60L 53/62; B60L 53/66; B60W 30/06; B60W 50/14; G07B 15/02

(52) U.S. Cl. CPC B60W 60/0023; B60L 53/305; B60L 53/36; B60L 53/62; B60L 53/66; B60W 30/06; B60W 50/14; G07B 15/02

(57) ABSTRACT

A server apparatus includes one or more processors and a storage medium storing a program. The program includes one or more instructions. The one or more instructions cause the one or more processors to execute: instructing an automatically drivable provider vehicle of a provider who provides a user with a charger installed in a parking space designated for use by the provider to move to a predetermined waiting area; transmitting a provider return notification to the user; instructing the provider vehicle to move from the waiting area to the parking space in accordance with a detection of an exit of the user vehicle from the parking space; transmitting a return notification to the provider in response to a return of the provider vehicle to the parking space; and increasing or decreasing a fee to be paid by the user or a profit to be provided to the provider.

### CROSS REFERENCE TO RELATED APPLICATIONS

This application is continuation of International Application No. PCT/JP2023/024364, filed on Jun. 30, 2023, the entire contents of which are hereby incorporated by reference.

### BACKGROUND

The disclosure relates to a server apparatus, and relates to a technique for providing a charging spot to a user of an electric vehicle or the like.

Japanese Unexamined Patent Application Publication No. 2019-185308 relates to charging of an electric vehicle and describes making a user's charging equipment at home such as household charging equipment charging equipment open to other users.

### SUMMARY

An aspect of the disclosure provides a server apparatus including one or more processors and a storage medium. The storage medium stores a program configured to be executed by the one or more processors. The program includes one or more instructions. The one or more instructions cause the one or more processors to execute instructing a provider vehicle of a provider who provides a user with a charger installed in a parking space designated for use by the provider to move to a predetermined waiting area in accordance with an exit of an occupant from the provider vehicle when the provider vehicle is to return to the parking space and the parking space is occupied by a user vehicle of the user, the provider vehicle being an automatically drivable vehicle. The one or more instructions cause the one or more processors to execute transmitting a provider return notification to a terminal used by the user when the provider vehicle is to return to the parking space occupied by the user vehicle. The one or more instructions cause the one or more processors to execute instructing the provider vehicle to move from the waiting area to the parking space in accordance with a detection of an exit of the user vehicle from the parking space. The one or more instructions cause the one or more processors to execute transmitting a return notification to a terminal used by the provider in response to a return of the provider vehicle to the parking space. The one or more instructions cause the one or more processors to execute increasing or decreasing a fee to be paid by the user or a profit to be provided to the provider in accordance with a relationship between a date and time of the return of the provider vehicle and a scheduled charging end date and time and in accordance with whether the user vehicle has exited the parking space.

An aspect of the disclosure provides a server apparatus including one or more processors and a storage medium. The storage medium stores a program configured to be executed by the one or more processors. The program includes one or more instructions. The one or more instructions cause the one or more processors to execute instructing a provider vehicle of a provider who provides a user with a charger installed in a parking space designated for use by the provider to move to a predetermined waiting area in accordance with an exit of an occupant from the provider vehicle when the provider vehicle is to return to the parking space and the parking space is occupied by a user vehicle of the user. The provider vehicle is an automatically drivable vehicle. The one or more instructions cause the one or more processors to execute instructing the provider vehicle to move from the waiting area to the parking space in accordance with a detection of an exit of the user vehicle from the parking space. The one or more instructions cause the one or more processors to execute transmitting a return notification to a terminal used by the provider in response to a return of the provider vehicle to the parking space. The one or more instructions cause the one or more processors to execute, in response to a request from the provider for the user vehicle to exit the parking space and a request from the user to continue charging the user vehicle in the parking space, performing a determination on which of the request from the provider and the request from the user to give priority to in accordance with a use condition, and executing processing for the exit of the user vehicle or continuation of charging of the user vehicle in accordance with the determination.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a diagram illustrating a configuration of a system according to an embodiment of the disclosure;

FIG. 2 is a block diagram of an information processing apparatus such as a server apparatus according to the embodiment;

FIG. 3 is a block diagram illustrating a configuration of a vehicle according to the embodiment;

FIG. 4 is a diagram illustrating a procedure of a charger rental service according to the embodiment;

FIG. 5 is a diagram illustrating a functional configuration of the server apparatus according to the embodiment;

FIG. 6 is a diagram illustrating a functional configuration of a user terminal according to the embodiment;

FIG. 7 is a diagram illustrating a functional configuration of a provider terminal according to the embodiment;

FIG. 8 is a flowchart of a processing example according to the embodiment;

FIG. 9 is a flowchart of the processing example according to the embodiment;

FIG. 10 is a flowchart of a processing example according to the embodiment;

FIG. 11 is a flowchart of a processing example according to the embodiment; and

FIG. 12 is a flowchart of a processing example according to the embodiment.

### DETAILED DESCRIPTION

In recent years, electric vehicles have become increasingly widespread. When the remaining charge of an electric vehicle becomes low in a location away from home, no charging facility (charging spot) may be located nearby. For example, a mountainous area away from an urban area is expected to have a small number of stores as charging stations.

In a household having a charging spot (charger) at home, the charger is not used while the people of the household go out by vehicle, and the utilization rate of the charger decreases. In a case where a charger at home is rented and used by another person, a parking space at home is occupied by the person. If the renter returns home before the person completes the charging, the renter may not be able to park in the parking space. For the reasons described above, when a personal residence is used as a charging spot, it is difficult to make adjustments on the use of the charger. Such adjustments are difficult, for example, when a provider who provides the charger returns home during charging by another person.

Accordingly, an embodiment of the disclosure provides a technique for making adjustments when during the renting of a personal home charger, a provider of the charger returns home.

### System Configuration

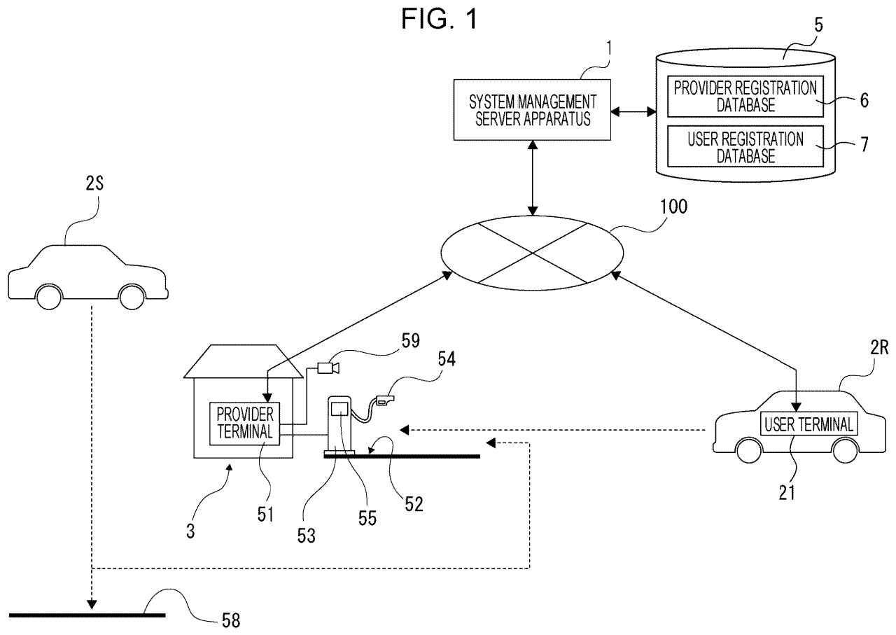

FIG. 1 illustrates a configuration of a system for a charger rental service according to an embodiment. The system is a system that can make adjustments between a provider of a charger and a user who wishes to rent the charger. In the system, a system management server apparatus 1 (hereinafter referred to as a “server apparatus 1”), a user terminal 21, and a provider terminal 51 can communicate with each other via a network 100.

The user is a person who is registered as a user in a charger rental service provided by the server apparatus 1. A person who wishes to use the charger rental service is registered as a user and is accordingly permitted to use a charger 53 of another person for a fee, for example.

A vehicle used by the user is represented as a user vehicle 2R.

The provider is a person who allows the charger 53 installed in a parking space 52 used by the provider to be rented to another person and who is registered as a provider in the charger rental service provided by the server apparatus 1. A person who becomes a registered provider can receive a reward in compensation for allowing another person to use the charger 53.

A vehicle used by the provider is represented as a provider vehicle 2S.

The user terminal 21 is an information processing apparatus used by the user, and is a terminal apparatus capable of communicating with at least the server apparatus 1 via the network 100. For example, an information processing apparatus in the user vehicle 2R may be used as the user terminal 21, or an information processing apparatus such as a smartphone, a personal computer, or a tablet device carried by the user may be used as the user terminal 21.

The user who uses the user terminal 21 can use the user terminal 21 to enjoy a service provided by the system by, for example, browsing a web site provided by the server apparatus 1 or activating an application program.

The provider terminal 51 is an information processing apparatus used by the provider, and is a terminal apparatus capable of communicating with at least the server apparatus 1 via the network 100. For example, the provider terminal 51 may be a personal computer or the like in a house 3 or the like of the provider, or may be an information processing apparatus built in the charger 53. The provider terminal 51 may be a smartphone, a tablet device, or the like carried by the provider. Alternatively, an information processing apparatus in the provider vehicle 2S used by the provider may be the provider terminal 51.

An information processing apparatus located in the house 3 or built in the charger 53 and a smartphone, a tablet device, or the like carried by the provider may be synchronized and used as the provider terminal 51.

Further, a smartphone, a tablet device, or the like carried by the provider may be used as a user interface device, for the provider, of the provider terminal 51 located in the house 3 or built in the charger 53.

The provider terminal 51 performs, for example, a process of transmitting provision information to the server apparatus 1 in accordance with the convenience of the provider, and a process of transmitting information on the rental status of the charger 53 to the server apparatus 1. Accordingly, the provider terminal 51 is any information processing apparatus capable of performing the processes described above, and is not limited to a specific form. For example, a smartphone used by the provider and an information processing apparatus in the charger 53 may cooperate with each other to serve as the provider terminal 51.

The server apparatus 1 is a server apparatus of a company or the like that operates the charger rental service, and includes one or more information processing apparatuses. The server apparatus 1 can access a storage device 5. The storage device 5 includes a provider registration database 6 for registering providers and a user registration database 7 for registering users.

The server apparatus 1 communicates with the user terminal 21 and the provider terminal 51 to coordinate between the user and the provider, and provides a service of performing matching so that charging is performed at a place and date and time desired by the user. This allows the user to charge the user vehicle 2R even in an area where there are not sufficient charging stations and the like. The provider is given a reward for charger rental. Thus, the provider is provided with a simple business opportunity.

The charger 53 is installed in the parking space 52 in the house 3 of the provider. The provider vehicle 2S is usually parked in the parking space 52 and charged by the charger 53. The charger rental service according to the present embodiment allows the user to charge the user vehicle 2R when the provider is out with the provider vehicle 2S and the parking space 52 and the charger 53 are vacant.

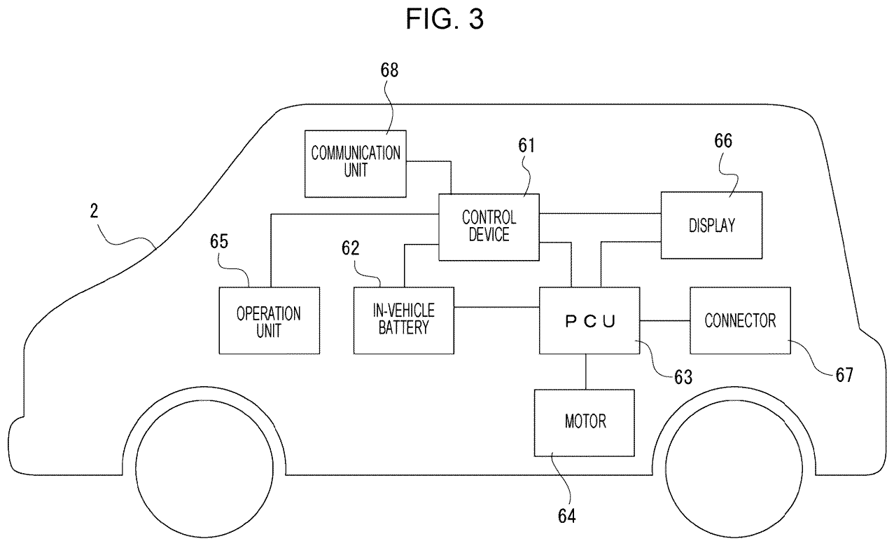

The charger 53 is provided with a panel 55 as a display or an operation panel. For example, the panel 55 can guide the user to operate or use the charger 53 at the time of charging. The user couples a gun 54 to a connector 67 (see FIG. 3), which is a charging port of the user vehicle 2R, and performs charging.

The charger 53 is internally provided with a measurement circuit for measuring the amount of charge, and the measurement circuit measures the amount of charge during charging. The provider terminal 51 can acquire information on the amount of charge measured by the measurement circuit.

In the illustrated example, a camera 59 is installed in the parking space 52, by way of example. The camera 59 can capture, for example, an image of a license plate or a car body of the user vehicle 2R or an image of the user vehicle 2R during charging. The provider terminal 51 can acquire information on the user vehicle 2R, such as a vehicle number and a vehicle type, for example, from the image captured by the camera 59. Alternatively, the provider terminal 51 may transmit data of the image to the server apparatus 1, and the server apparatus 1 may detect the vehicle number, the vehicle type, and the like.

In addition, the provider terminal 51 and the server apparatus 1 can check the entry or exit of the user vehicle 2R to or from the parking space 52 by using the image captured by the camera 59.

FIG. 1 illustrates the charger 53 installed in the parking space 52 in the house 3, and the house 3 may be any type of house such as a detached house or a multiple dwelling house. In addition, the parking space 52 may be a parking space that is away from the house 3 and where the provider usually parks.

In the present embodiment, the charger 53, which is a target of the charger rental service, is a charger installed in the parking space 52 designated for use by the provider. Examples of the parking space 52 include a parking space on the premises of the house 3 as a home, and a parking space that is away from the home but is owned or rented by the provider.

The charger 53 is a charger owned or rented by the provider as a charger usually used by the provider or their family.

However, the above is an example of a case where the provider is an individual. The provider according to the present embodiment may be a company, an organization, or the like, and a parking lot or a charger of the company or the like may be the parking space 52 or the charger 53 in FIG. 1.

In addition, when the charger rental service is implemented, a waiting area 58 is set for the provider vehicle 2S. The waiting area 58 is a location where, for example, the provider can temporarily park the provider vehicle 2S if the user vehicle 2R still occupies the parking space 52 when the provider returns home (or the provider vehicle 2S returns to the parking space 52). For example, the provider determines the waiting area 58 on the premises of the house 3 or near the house 3, and registers position information or the like of the waiting area 58 in the server apparatus 1.

### Configuration of Information Processing Apparatus

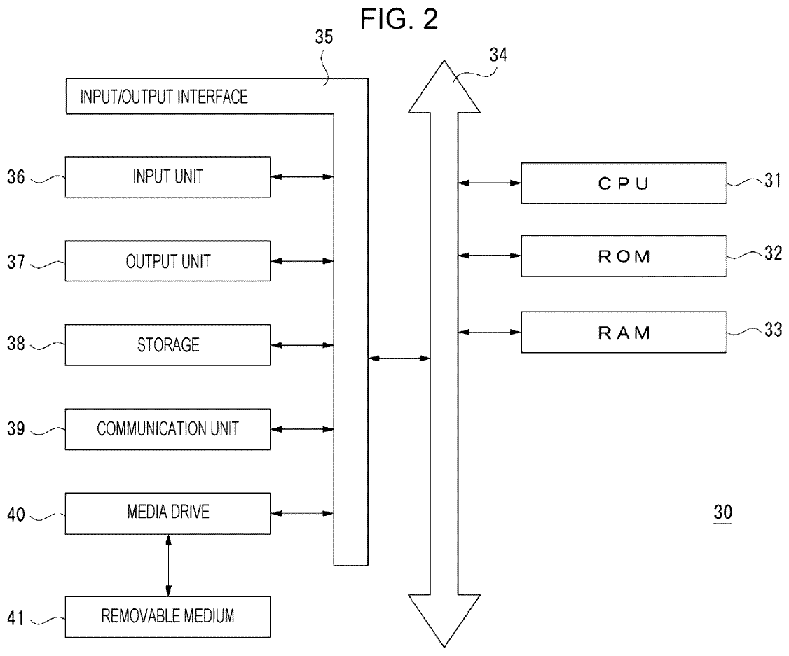

FIG. 2 illustrates an example configuration of an information processing apparatus 30 that can be used as the server apparatus 1, the user terminal 21, or the provider terminal 51.

The information processing apparatus 30 includes a central processing unit (CPU) 31, a read only memory (ROM) 32, a random access memory (RAM) 33, a bus 34, an input/output interface 35, an input unit 36, an output unit 37, a storage 38, a communication unit 39, a media drive 40, and the like.

The CPU 31 executes various processes in accordance with a program stored in the ROM 32 or a program loaded from the storage 38 to the RAM 33. The RAM 33 also stores information necessary for the CPU 31 to execute various processes.

The CPU 31, the ROM 32, and the RAM 33 are coupled to each other via the bus 34. The input/output interface 35 is also coupled to the bus 34.

The input unit 36, the output unit 37, the storage 38, the communication unit 39, and the media drive 40 are coupled to the input/output interface 35.

The input unit 36 includes a keyboard, a mouse, a touch panel, a microphone, and the like.

The output unit 37 includes a display such as a liquid crystal display (LCD) or an organic electroluminescent (EL) panel, a speaker, and the like.

The storage 38 includes a hard disk drive (HDD), a flash memory device, and the like. When the information processing apparatus 30 having the configuration described above is applied as the server apparatus 1, the storage 38 may form a database that stores registration information and the like.

The communication unit 39 performs communication processing and inter-device communication via a communication network.

For example, a removable medium 41, such as a semiconductor memory card, is placed on the media drive 40, and information is written to or read from the removable medium 41.

In the information processing apparatus 30, data or a program is uploaded or downloaded through communication by the communication unit 39. Further, data or a program can be transferred via the removable medium 41.

The CPU 31 performs processing operations based on various programs to execute information processing and communication necessary for the server apparatus 1, the user terminal 21, or the provider terminal 51.

### Vehicle Configuration

A system in a vehicle may be used as the user terminal 21 or the provider terminal 51. FIG. 3 illustrates a configuration of a vehicle 2 related to charging and an example configuration serving as the user terminal 21 or the provider terminal 51. The vehicle 2 collectively refers to the provider vehicle 2S and the user vehicle 2R.

The vehicle 2 includes a control device 61, an in-vehicle battery 62, a power control unit (PCU) 63, a motor 64, an operation unit 65, a display 66, the connector 67, and a communication unit 68.

Some of the components of the vehicle 2 are illustrated in FIG. 3, and the vehicle 2 includes a map locator, various sensors for driving the vehicle 2, a communication device, and so on, which are not illustrated in FIG. 3.

The control device 61 includes a CPU, a memory, and the like, and performs overall control of the vehicle 2. The control device 61 may be provided as a single unit or may include electronic control units (ECUs). The ECUs may include various ECUs. Examples of such ECUs include a battery control ECU for performing charging control of the in-vehicle battery 62, a display control ECU for performing display control of a display device (also including a meter or the like) included in the vehicle 2, an airbag control ECU, and an air-conditioning control ECU.

In the present embodiment, it is assumed that the vehicle 2 (at least the provider vehicle 2S) is an automobile that travels by automatic driving. For this reason, the vehicle 2 is also equipped with an information processing apparatus necessary for automatic driving. For example, the control device 61 may also include an automatic driving ECU for performing traveling route determination or control according to an external environment, a traveling control ECU for performing control to travel or stop traveling by using a motor in accordance with an instruction from the automatic driving ECU, a steering control ECU for performing steering control in accordance with an instruction from the automatic driving ECU, and the like.

Although not illustrated, the vehicle 2 is also equipped with devices for sensing the surroundings, such as a camera and a sensor, and devices for performing detection to obtain map information, road information, current position information, and the like, for automatic driving control.

Automatic driving is performed in response to, for example, a destination designation operation by the occupant. In the present embodiment, automatic driving is also performed in response to a destination designation command from the server apparatus 1. For example, in response to the communication unit 68 receiving a movement instruction from the server apparatus 1, the provider vehicle 2S automatically travels to the destination, for example, the waiting area 58 or the parking space 52 at home. Alternatively, the movement instruction from the server apparatus 1 may be received by the communication unit 68 via the provider terminal 51 when a smartphone or the like of the provider is the provider terminal 51. Also in this case, the provider vehicle 2S automatically travels to, for example, the waiting area 58 or the parking space 52 at home in response to the movement instruction.

Automatic driving also includes automatic driving for parking, for example, so-called “perpendicular parking” or “parallel parking”.

The control device 61 executes various programs stored in the memory or the like to implement various functions.

Accordingly, the control device 61 can have a configuration equivalent to the configuration illustrated in FIG. 2.

The in-vehicle battery 62 is a high-voltage battery used for driving of the vehicle 2. The in-vehicle battery 62 supplies electric power to be used for driving wheels of the vehicle 2, electric power to be used for operating an air conditioner of the vehicle 2, and electric power to be used for operating other devices of the vehicle 2. In FIG. 3, the supply of electric power to be used for driving the wheels from the in-vehicle battery 62 and the supply of electric power from the in-vehicle battery 62 to the display 66 are illustrated, but the supply of electric power to be used for the operations of the other components is not illustrated.

The in-vehicle battery 62 is charged by a current supplied from the PCU 63.

The in-vehicle battery 62 supplies a power supply voltage to the PCU 63 to drive the motor 64.

The PCU 63 includes an inverter, a direct current to direct current (DC-DC) converter, and so on to drive the motor 64.

The PCU 63 generates, based on the supplied power supply voltage, an alternating-current (AC) current for driving the motor 64 and supplies the AC current to the motor 64. The PCU 63 controls the AC current to perform torque control of the motor 64. The PCU 63 may have a regenerative braking function to optimize energy efficiency using regenerative energy.

The motor 64 is configured as a motor generator having an electric power generation function. The motor 64 drives the wheels based on the supplied AC current.

The operation unit 65 includes, for example, operating elements such as various buttons and levers arranged in front of a driver's seat of the vehicle 2. The operation unit 65 may also include a multi-function display (MFD) having a touch panel function, a display of a navigation system, and so on.

The display 66 is a generic representation of, for example, an MFD installed in front of the driver and other display devices for presenting information to the driver. The display 66 performs display based on detection signals detected by the various sensors included in the vehicle 2. The display 66 appropriately displays various kinds of information such as a total travel distance of the vehicle 2, an outside air temperature, and instantaneous fuel efficiency. The display 66 can also display map information, extracted route information, and so on.

The display 66 may display a screen of the charger rental service according to the present embodiment.

The connector 67 has a structure such that a charging plug (the gun 54) included in charging equipment such as the charger 53 can be inserted into the connector 67. The connector 67 outputs an AC voltage supplied through the inserted charging plug to the PCU 63. The PCU 63 includes an AC-DC converter and supplies a DC voltage, which is obtained by conversion, to the in-vehicle battery 62 to charge the in-vehicle battery 62.

The communication unit 68 includes a wireless communication device, and communicates with the server apparatus 1 or the like via the network 100, for example.

### Overview of Charger Rental Service

An overview of the charger rental service provided by the server apparatus 1 will be described.

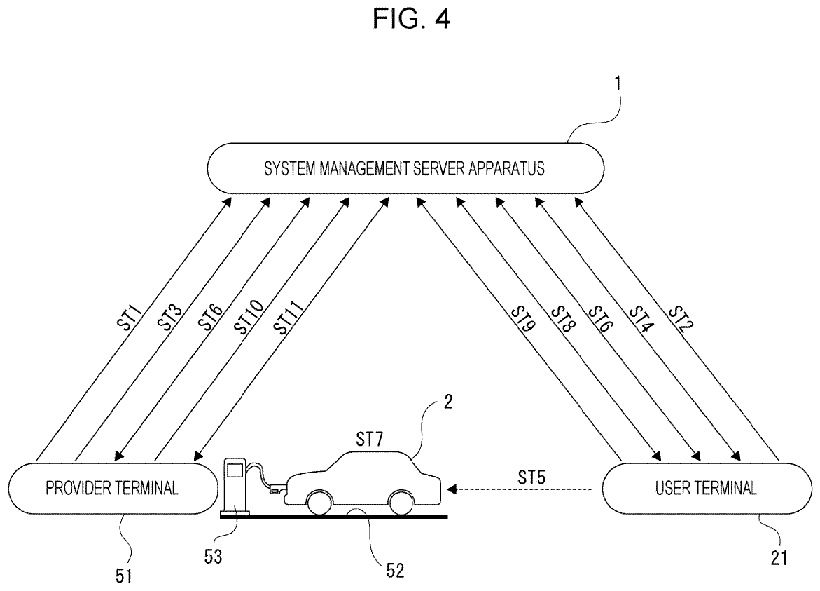

The service, including the actions of the user and the provider, is implemented by a procedure from ST1 to ST11 illustrated in FIG. 4.
(ST1) A service user who is to be the provider uses the provider terminal 51 to register the charger 53, which is rentable, in the server apparatus 1. In one example, personal information of the provider, information for payment, position information of the parking space 52 and the waiting area 58, and information such as a model and specifications of the charger 53 are registered.
(ST2) A service user who is to be the user uses the user terminal 21 to register user information (such as vehicle information and personal information) in the server apparatus 1.
(ST3) The provider uses the provider terminal 51 to transmit provision information including date and time information indicating a date and time when the charger 53 can be rented, to the server apparatus 1 at any time point. The provision information is information for informing the server apparatus 1 that the provider can provide the parking space 52 to another person for a time period from a certain date and time to a certain date and time.
(ST4) The user uses the user terminal 21 to transmit a use request to the server apparatus 1 at any time point to use the charger 53. The use request includes information such as an area and a date and time where and when the user is to use the charger 53. In response to the request from the user, the server apparatus 1 selects a provider that matches the request in terms of the area and the date and time among providers from which provision information has been received, and provides the user with information on a list of chargers 53 that can be rented. The user selects a charger 53 that the user is to use from among the chargers 53 that can be rented, and performs a decision operation for deciding to make a reservation for use to the server apparatus 1. The server apparatus 1 performs reservation setting in accordance with the decision operation.
(ST5) The user vehicle 2R moves to the parking space 52 in which the charger 53 is installed on the reserved date and time.
(ST6) When using the charger 53, the user is authenticated by either the user terminal 21 or the provider terminal 51 or both. The authentication result is also shared by the server apparatus 1.
(ST7) The user performs charging. At this time, the amount of charge is also measured by the provider terminal 51.
(ST8) After the charging is completed, a process for paying the fee is performed between the user terminal 21 and the server apparatus 1.
(ST9) The user transmits evaluation information of the provider by using the user terminal 21 (or a device such as a smartphone serving as a user interface device of the user terminal 21).
(ST10) The provider transmits the evaluation of the user to the server apparatus 1 by using the provider terminal 51.
(ST11) The server apparatus 1 gives a reward to the provider.

The order of (ST8), (ST9), (ST10), and (ST11) may be different from that described above. The processes of (ST1), (ST2), (ST3), and (ST4) are sequentially performed between an unspecified number of service users and the server apparatus 1.

A functional configuration of the server apparatus 1 for executing the charger rental service as described above will be described. For example, the server apparatus 1 having the configuration of the information processing apparatus 30 illustrated in FIG. 2 implements various functions when the CPU 31 executes a program.

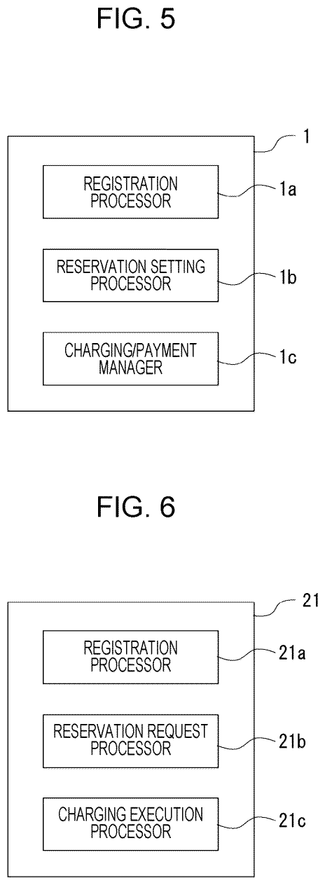

FIG. 5 illustrates an example of functions provided in the CPU 31 for the charger rental service according to the present embodiment.

A registration processor 1a is a function of performing processing related to registration of the user and the provider. The server apparatus 1 provides the charger rental service to a service user registered as the user. The server apparatus 1 further provides the user with information on the charger 53 of a service user who satisfies the condition among the service users registered as providers. That is, the registration processor 1a is a function of performing processing related to (ST1) and (ST2) described above.

A reservation setting processor 1b is a function of performing processing for setting a reservation for charger rental between the user and the provider. Accordingly, the reservation setting processor 1b performs processing related to provision information from the provider. The provision information includes date and time information indicating a date and time when the provider can provide the charger 53 and the parking space 52 to another person. For example, the date and time information is information including an available rental start date and time and an available rental end date and time. The reservation setting processor 1b also performs processing for receiving a reservation request from the user and introducing a provider who satisfies the condition to the user. That is, the reservation setting processor 1b is a function of performing processing related to (ST3) and (ST4) described above.

A charging/payment manager 1c is a function of performing management processing such as management related to the use of the charger 53 by the user, the payment made by the user, and the provision of a reward to the provider.

The charging/payment manager 1c also performs adjustment processing when the user and the provider meet at the parking space 52. The adjustment processing will be described in detail below.

The charging/payment manager 1c has a function of performing processing related to (ST6) to (ST11) described above.

Next, a functional configuration of the user terminal 21 will be described. For example, the user terminal 21 having the configuration of the information processing apparatus 30 illustrated in FIG. 2 or the user terminal 21 implemented as the control device 61 illustrated in FIG. 3 implements various functions when the CPU 31 executes a program. FIG. 6 illustrates an example of functions provided in the CPU 31 of the user terminal 21 for the charger rental service according to the present embodiment.

A registration processor 21a is a user interface for the user to perform user registration or a function of performing processing such as transmission of registration information to the server apparatus 1. That is, the registration processor 1a is a function of performing processing related to (ST2) described above.

A reservation request processor 21b is a user interface for the user to make a use request or a function of communicating with the server apparatus 1. That is, the reservation request processor 21b is a function of performing processing related to (ST4) described above.

A charging execution processor 21c is a function of performing processing for the user to perform charging using the charger 53, for example, authentication processing and communication with the server apparatus 1. That is, the charging execution processor 21c is a function of performing processing related to (ST6), (ST8), and (ST9) described above.

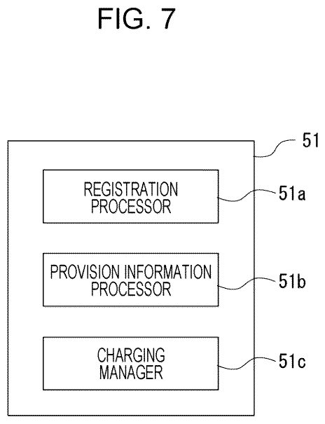

Next, a functional configuration of the provider terminal 51 will be described. For example, the provider terminal 51 having the configuration of the information processing apparatus 30 illustrated in FIG. 2 or the provider terminal 51 implemented as the control device 61 illustrated in FIG. 3 implements various functions when the CPU 31 executes a program. FIG. 7 illustrates an example of functions provided in the CPU 31 of the provider terminal 51 for the charger rental service according to the present embodiment.

A registration processor 51a is an interface for the provider to perform provider registration or a function of performing processing such as transmission of registration information to the server apparatus 1. That is, the registration processor 51a is a function of performing processing related to (ST1) described above.

A provision information processor 51b is a user interface or a communication function for transmitting, to the server apparatus 1, provision information indicating a date and time when the provider can rent the charger 53. That is, the provision information processor 51b is a function of performing processing related to (ST3) described above.

A charging manager 51c is a function of performing processing for the user to perform charging using the charger 53, for example, authentication processing and processing related to measurement of the amount of charge and the amount of electric power and payment, and operations involved in such processing, such as communication with the server apparatus 1. That is, the charging manager 51c is a function of performing processing related to (ST6), (ST7), (ST10), and (ST11) described above.

Hereinafter, processing examples executed by the server apparatus 1 will be described. A first processing example, a second processing example, a third processing example, and a fourth processing example described below are adjustment processing in a case where the user vehicle 2R occupies the parking space 52 when the provider vehicle 2S is to return to the parking space 52.

### First Processing Example

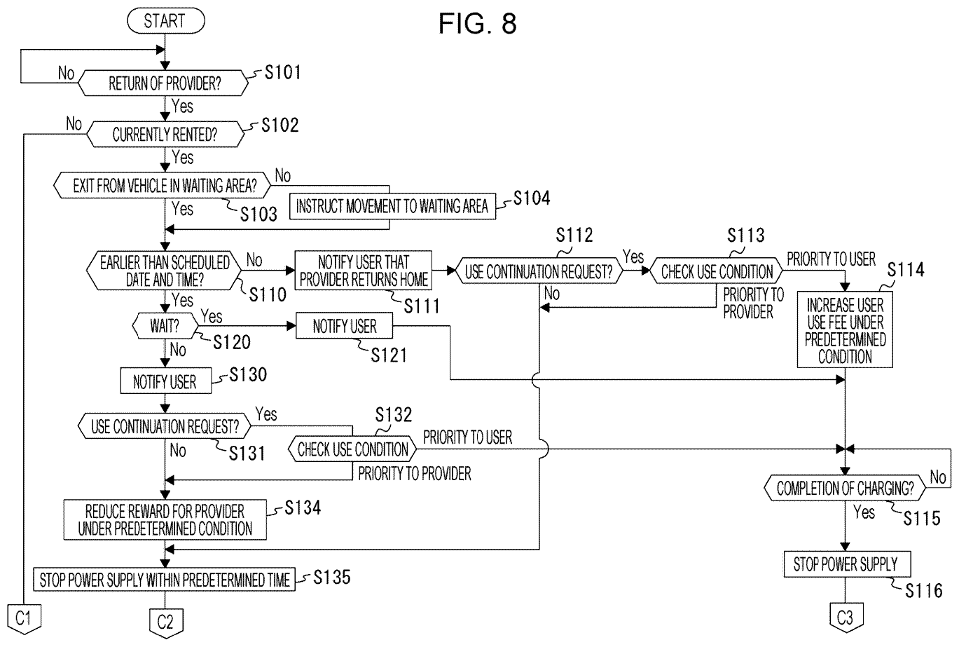

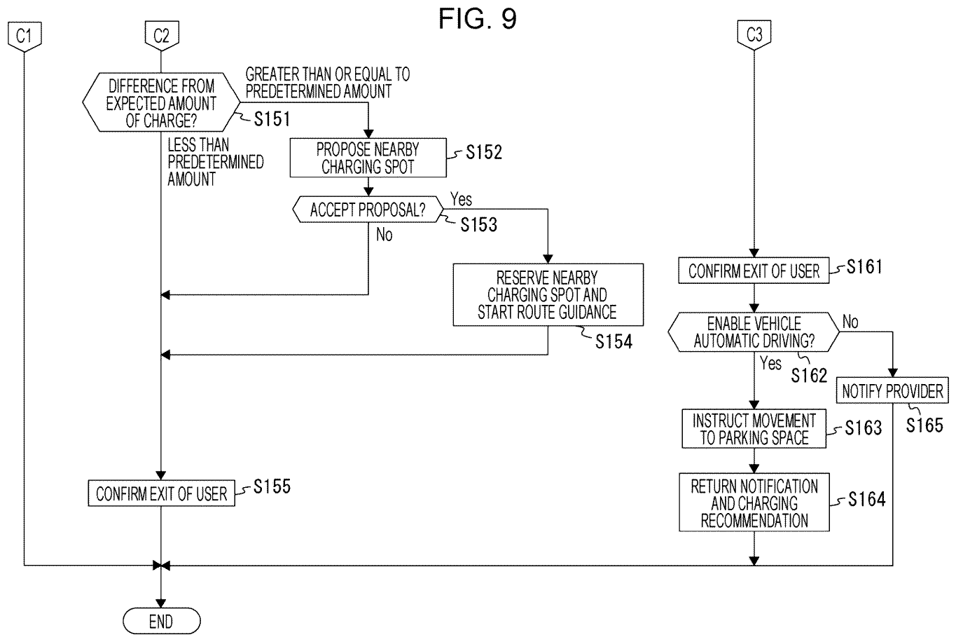

The first processing example performed by the server apparatus 1 will be described with reference to FIGS. 8 and 9. In the flowchart illustrated in FIGS. 8 and 9, the signs “C1”, “C2”, and “C3” indicate the connections between FIGS. 8 and 9.

In step S101 of FIG. 8, the server apparatus 1 determines whether the provider vehicle 2S returns to the parking space 52. That is, when the provider returns home, the server apparatus 1 determines that the provider vehicle 2S returns to the parking space 52. If it is determined in step S101 that the provider vehicle 2S returns to the parking space 52, the processing of step S102 and the subsequent steps is started.

The determination of the return of the provider vehicle 2S may be performed by the server apparatus 1 automatically or in accordance with an operation of the provider.

To perform the determination automatically, the server apparatus 1 sets a checkpoint in advance near the parking space 52, for example. At the time of registration in (ST1) described above, the provider may input, as a checkpoint, a location where the provider always passes near the parking space 52 to return home, and register the checkpoint in the server apparatus 1. Alternatively, the server apparatus 1 may automatically set a transit point or the like on a nearby road as a checkpoint, based on the position information of the parking space 52. During rental, the server apparatus 1 continuously receives position information of the provider vehicle 2S. As a result, the arrival of the provider vehicle 2S at the checkpoint, that is, the return of the provider vehicle 2S, is detectable.

Examples of the determination in accordance with an operation of the provider include an operation performed by the provider using the provider terminal 51 to express a return intention when the provider arrives near the parking space 52. The provider terminal 51 transmits information on the operation to the server apparatus 1, and accordingly, the server apparatus 1 can determine the return of the provider vehicle 2S.

In step S102, the server apparatus 1 determines whether the charger 53 is currently being rented. Even within the rental time of the user, the charging may have been completed, and the user vehicle 2R may have exited the parking space 52. In this case, the adjustment processing is no longer necessary. Thus, the process illustrated in FIGS. 8 and 9 ends.

If the user vehicle 2R is still in the parking space 52 during the rental, that is, at the time of the return of the provider vehicle 2S, in step S103, the server apparatus 1 determines whether the provider vehicle 2S is in the waiting area 58 and an occupant has exited the provider vehicle 2S. The server apparatus 1 determines whether the occupant has exited the provider vehicle 2S by, for example, receiving exit determination information based on information from a sensor in a seat of the provider vehicle 2S or an image from an in-vehicle camera.

If the occupant such as the provider has exited the provider vehicle 2S in the waiting area 58, the server apparatus 1 keeps the provider vehicle 2S waiting in the waiting area 58 without providing an instruction.

If the occupant has exited the provider vehicle 2S in a location other than the waiting area 58, in step S104, the server apparatus 1 provides an instruction to the provider vehicle 2S to move to the waiting area 58 by automatic driving. As a result, the provider vehicle 2S waits in the waiting area 58.

In any case, the occupant can exit the provider vehicle 2S and return home to the house 3.

In step S110, the server apparatus 1 determines whether the return is earlier than a scheduled date and time (rental end date and time).

If the scheduled date and time has passed, the user vehicle 2R would have left the parking space 52. In this case, in step S111, the server apparatus 1 notifies the user terminal 21 of the return of the provider. The user terminal 21 displays this notification to prompt the user to perform a corresponding operation. For example, the user performs an acceptance operation, finishes charging, and causes the user vehicle 2R to leave the parking space 52.

If information on acceptance is received from the user vehicle 2R, the server apparatus 1 proceeds from step S112 to step S135, and instructs the provider terminal 51 to stop the power supply within a predetermined time.

However, the user may wish to continuously perform charging. Accordingly, the user is allowed to transmit a use continuation request from the user terminal 21 to the server apparatus 1.

If the use continuation request is received, in step S113, the server apparatus 1 checks a use condition. That is, the use condition is a condition indicating which of the user vehicle 2R and the provider vehicle 2S to give priority to when the user vehicle 2R and the provider vehicle 2S meet in the parking space 52. A basic priority condition may be determined by a contract in advance, or, for example, the provider may set the priority given to the user or the like at the time of reservation confirmation. In addition, whether the current date and time are earlier or later than the rental end date and time may be included in the determination condition. The server apparatus 1 determines which one to give priority to in the current case, based on, for example, the contract and setting information at the time of reservation confirmation.

If it is determined that priority is given to the provider in the current case, the server apparatus 1 determines that the use continuation request is not acceptable, and then proceeds to step S135. In this case, the charging is terminated, and the user vehicle 2R is made to exit the parking space 52.

If it is determined that priority is given to the user in the current case, the server apparatus 1 accepts the use continuation request and permits the continuation of charging. In this case, however, the user continues to rent the charger 53 beyond the scheduled exit date and time. Thus, in step S114, the server apparatus 1 performs a process of increasing the use fee charged to the user under a predetermined condition.

Then, in step S115, the server apparatus 1 waits for the completion of charging. When the charging is completed, in step S116, the server apparatus 1 instructs the provider terminal 51 to stop the power supply.

The foregoing describes a case where the provider vehicle 2S returns after the scheduled date and time. The provider vehicle 2S may return earlier than the scheduled date and time.

In this case, the server apparatus 1 proceeds from step S110 to step S120, notifies the provider terminal 51 of a request for a response as to how to address this situation, and checks response information. For example, it is possible to select whether to wait for the completion of charging or to request the user to exit the parking space 52.

The provider knows that the return is earlier than scheduled and is thus considered to wait until the scheduled date and time. In this case, the provider operates the provider terminal 51 and transmits a response indicating that the provider is waiting to the server apparatus 1.

In this case, the server apparatus 1 proceeds from step S120 to step S121, and notifies the user terminal 21 that the provider has returned but is waiting. Then, in step S115, the server apparatus 1 waits for the completion of charging. When the charging is completed, in step S116, the server apparatus 1 instructs the provider terminal 51 to stop the power supply.

On the other hand, in step S120, the provider may be considered to make the user vehicle 2R exit the parking space 52 earlier than scheduled for some reason. In this case, the provider operates the provider terminal 51 and transmits a response to the server apparatus 1 to request the user vehicle 2R to exit the parking space 52.

In this case, in step S130, the server apparatus 1 notifies the user terminal 21 of an exit request from the provider. In response to the notification, the user is allowed to transmit a response indicating that the user accepts the exit request or makes a use continuation request without accepting the exit request.

If information indicating acceptance of the exit request is received from the user terminal 21, the server apparatus 1 proceeds from step S131 to step S134, and performs a process of reducing the reward for the provider under a predetermined condition. This is to terminate the charging of the user vehicle 2R before the rental end date and time. In this case, the server apparatus 1 may perform a process of reducing the user's use fee at the same time.

Then, in step S135, the server apparatus 1 instructs the provider terminal 51 to stop the power supply within a predetermined time. For example, the predetermined time is set to about one minute to immediately terminate the charging and make the user vehicle 2R exit the parking space 52.

If, in step S131, a response indicating a request to continue using the charger 53 until the scheduled date and time is received from the user terminal 21, in step S132, the server apparatus 1 checks a use condition. In other words, as in step S113 described above, the server apparatus 1 determines which of the user and the provider to give priority to in the current case.

If it is determined that priority is given to the provider, the server apparatus 1 proceeds to step S134. Also in this case, the server apparatus 1 performs a process of reducing the reward for the provider under a predetermined condition although the priority is given to the provider, since the rental cannot be ended as reserved. Then, in step S135, the server apparatus 1 instructs the provider terminal 51 to stop the power supply within the predetermined time.

If it is determined in step S132 that priority is given to the user, the server apparatus 1 proceeds to step S115, and waits for the completion of charging. When the charging is completed, in step S116, the server apparatus 1 instructs the provider terminal 51 to stop the power supply.

In each of the above cases, the server apparatus 1 proceeds to steps S115 and S116 when the provider vehicle 2S is waiting in the waiting area 58. However, the occupant such as the provider has already exited the provider vehicle 2S and returned to the house 3.

In this case, as indicated by “C3”, the server apparatus 1 proceeds to step S161 of FIG. 9. In step S161, the server apparatus 1 confirms an exit of the user vehicle 2R from the parking space 52. For example, the provider terminal 51 confirms the exit of the user vehicle 2R by using the image from the camera 59, and transmits information on the exit to the server apparatus 1. As a result, the server apparatus 1 confirms the exit of the user vehicle 2R. Alternatively, the provider terminal 51 may transmit the image from the camera 59 to the server apparatus 1, and the server apparatus 1 may determine the exit from the image.

When confirming the exit of the user vehicle 2R, in step S162, the server apparatus 1 checks whether to enable the automatic driving of the provider vehicle 2S from the waiting area 58 to the parking space 52. Settings may be configured to disable automatic driving when, for example, the provider vehicle 2S is to be returned to the parking space 52 by the provider themselves.

If automatic driving is enabled, the server apparatus 1 proceeds to step S163, and transmits an instruction to the provider vehicle 2S to move to the parking space 52. In response to the instruction, the provider vehicle 2S autonomously travels to the parking space 52.

When the movement to the parking space 52 is completed, in step S164, the server apparatus 1 transmits a return notification to notify the provider terminal 51 (in this case, a smartphone or the like of the provider) of a return to the parking space 52. The return notification includes information on the remaining charge of the provider vehicle 2S. For example, information such as “a charge of 40%” is included.

In response to the return notification, the provider terminal 51 displays, to the provider, information indicating the completion of the movement of the provider vehicle 2S, the remaining charge, and a message or the like recommending charging.

A situation in which the provider vehicle 2S autonomously travels and returns to the parking space 52 after the provider has already returned home is considered to be a situation in which the provider in the house 3 is likely to forget to charge the provider vehicle 2S. Accordingly, the server apparatus 1 alerts the provider that the provider vehicle 2S is to be charged. In one example, the provider terminal 51 also displays the information on the remaining charge to allow the provider to accurately determine whether to actually perform charging. As a result, the provider can visit the parking space 52 and perform charging work as appropriate.

On the other hand, if automatic driving is not enabled, the server apparatus 1 proceeds from step S162 to step S165, and notifies the provider terminal 51 (such as the smartphone of the provider) that the parking space 52 has become available. Accordingly, the provider visits the waiting area 58 at any time point and returns the provider vehicle 2S to the parking space 52 in an autonomous traveling mode or a manual driving mode. In this case, the provider can check the remaining charge and can recognize the charging of the provider vehicle 2S after returning to the parking space 52. Thus, it is not necessary to alert the provider for charging.

In the various cases described with reference to FIG. 8, the server apparatus 1 proceeds to step S135 when the user stops charging and exits the parking space 52.

In this case, as indicated by “C2”, the server apparatus 1 proceeds to step S151 of FIG. 9. In step S151, the server apparatus 1 checks the state of charge of the user vehicle 2R. For example, the server apparatus 1 receives information on the actual amount of charge by the charger 53 from the provider terminal 51, and compares the actual amount of charge with an expected amount of charge set at the time of reservation. Then, the server apparatus 1 determines whether the difference between the actual amount of charge and the expected amount of charge is greater than or equal to a predetermined amount.

If the difference is less than the predetermined amount, in step S155, the server apparatus 1 confirms that the user vehicle 2R has exited the parking space 52, and then the process ends.

If the difference is greater than or equal to the predetermined amount, in step S152, the server apparatus 1 transmits a proposal for a nearby charging spot to the user terminal 21. The user checks the nearby charging spot by using the user terminal 21, and performs an operation of responding as to whether to accept the proposal.

If a response indicating that the user no longer accepts the proposal is received, the server apparatus 1 proceeds from step S153 to step S155. Then, the server apparatus 1 confirms the exit of the user vehicle 2R, and the process ends.

If a response indicating that the user accepts the proposal is received, the server apparatus 1 proceeds from step S153 to step S154, performs a process of reserving the nearby charging spot, and transmits route guidance information to the user vehicle 2R. As a result, the user can perform charging at another charging spot.

Then, in step S155, the server apparatus 1 confirms the exit of the user vehicle 2R, and the process ends.

Through the first processing example described above, the adjustment is performed in a case where the user vehicle 2R is present in the parking space 52 to which the provider vehicle 2S is to return.

### Second Processing Example

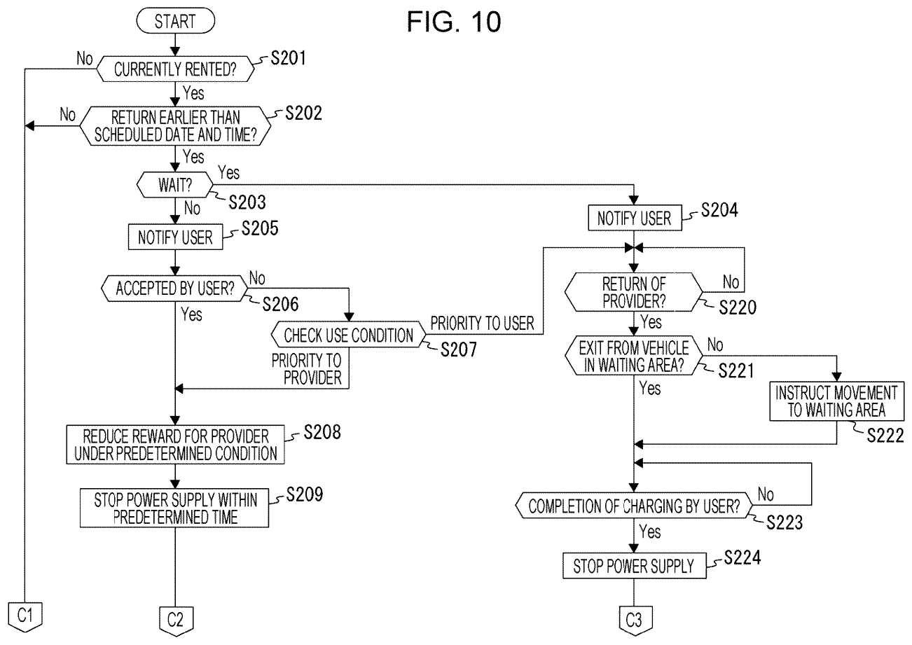

A second processing example will be described with reference to FIG. 10. The signs “C1”, “C2”, and “C3” in FIG. 10 lead to FIG. 9. The processing described with reference to FIG. 9 is also performed in a similar manner in the second processing example and third and fourth processing examples described below.

The second processing example is an example of a case where an early return of the provider vehicle 2S is known in advance. If it is determined in step S201 that the charger 53 is being rented, and if it is determined in step S202 that the provider vehicle 2S returns earlier than the scheduled date and time, the server apparatus 1 performs the processing of step S203 and the subsequent steps.

An early return of the provider returns is known in advance when, for example, the planned activity of the provider is changed and the provider terminal 51 (the smartphone or the like of the provider) notifies the server apparatus 1 of the return earlier than the rental end date and time.

If the notification is received, in step S203, the server apparatus 1 notifies the provider terminal 51 of a request for a response as to how to address this situation, and checks response information. For example, the provider is allowed to select whether to wait for the completion of charging or to request the user to exit the parking space 52.

If the provider selects to wait until the scheduled date and time and operates the provider terminal 51 to transmit a response indicating that the provider is waiting to the server apparatus 1, the server apparatus 1 proceeds from step S203 to step S204, and notifies the user terminal 21 that the provider returns earlier but waits.

Then, in step S220, the server apparatus 1 monitors the return of the provider. When the return of the provider is detected, in steps S221 and S222, the server apparatus 1 brings the provider vehicle 2S into a waiting state in the waiting area 58. The occupant such as the provider can exit the provider vehicle 2S and return home. The processing of steps S220, S221, and S222 is similar processes to that of steps S101, S103, and S104 of FIG. 8.

In step S223, the server apparatus 1 waits for the completion of charging of the user vehicle 2R. When the charging is completed, in step S224, the server apparatus 1 instructs the provider terminal 51 to stop the power supply.

Thereafter, the server apparatus 1 performs the processing of step S161 and the subsequent steps of FIG. 9.

If, in step S203, the provider operates the provider terminal 51 and transmits a response indicating a request for the exit of the user vehicle 2R to the server apparatus 1, in step S205, the server apparatus 1 notifies the user terminal 21 of an exit request from the provider. In response to the notification, the user transmits, from the user terminal 21, a response indicating that the user accepts the exit request or makes a use continuation request.

If, in step S206, a response indicating a request to continue using the charger 53 until the scheduled date and time is received from the user terminal 21, in step S207, the server apparatus 1 checks a use condition. If it is determined that priority is given to the user, the server apparatus 1 proceeds to the processing of step S220 and the subsequent steps. In other words, the server apparatus 1 performs the processing of steps S220 to S224 and step S161 and the subsequent steps of FIG. 9.

If information indicating acceptance of the exit request is received from the user terminal 21, the server apparatus 1 proceeds from step S206 to step S208, and performs a process of reducing the reward for the provider under a predetermined condition.

The server apparatus 1 also proceeds to step S208 if it is determined in step S207 that priority is given to the provider.

Then, in step S209, the server apparatus 1 instructs the provider terminal 51 to stop the power supply within a predetermined time.

In this case, the server apparatus 1 proposes another charging spot in the subsequent processing of step S151 and the subsequent steps of FIG. 9 for the convenience of the user.

In this case, however, there may be a sufficient time until the provider vehicle 2S actually returns. Accordingly, the predetermined time in this case may be set as a time until the predicted date and time of the actual return of the provider vehicle 2S, and the charging may be continued until the predicted date and time.

Alternatively, at this time, as in step S220, whether the provider vehicle 2S returns to the parking space 52 may be determined, and the charging may be continued until the return of the provider vehicle 2S is detected.

Thereafter, after actually stopping the power supply, the server apparatus 1 performs the processing of step S151 and the subsequent steps of FIG. 9.

Through the above-described process, in a case where an earlier return of the provider vehicle 2S is known in advance, the adjustment is performed before the time point of the actual return of the provider vehicle 2S, and a response to the user can be determined.

### Third Processing Example

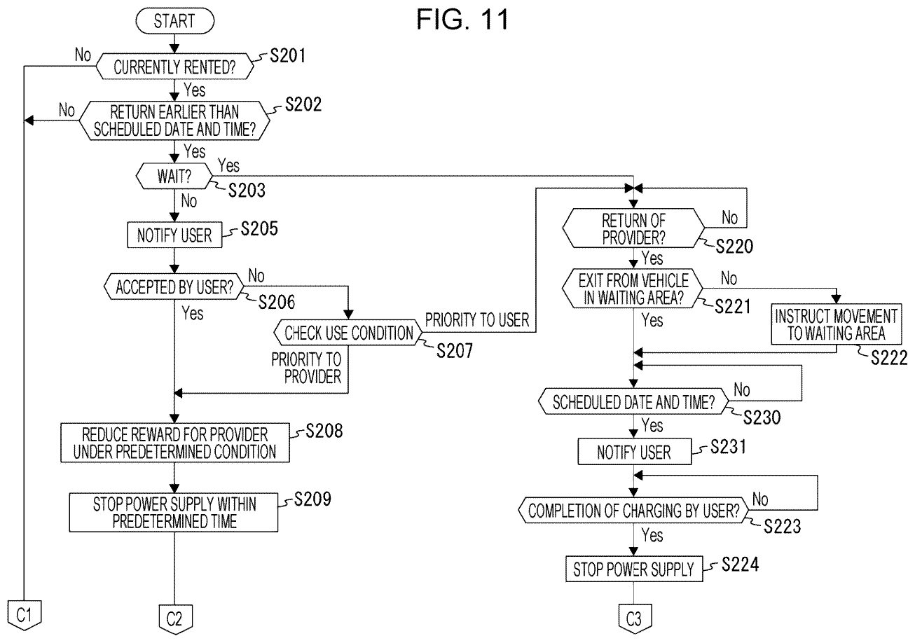

A third processing example will be described with reference to FIG. 11. The signs “C1”, “C2”, and “C3” in FIG. 11 lead to FIG. 9. The third processing example is also an example of a case where an early return of the provider vehicle 2S is known in advance, and only differences from FIG. 10 will be described.

The processing example in FIG. 11 is different from that in FIG. 10 in that the notification in step S204 of FIG. 10 is not performed and notification is performed in steps S230 and S231.

The notification in step S204 of FIG. 10 notifies the users that the provider returns earlier even when the provider has an intention to wait. Such notification may impose psychological pressure on the user although the user performs the charging as reserved.

In the example in FIG. 11, accordingly, in step S230, the server apparatus 1 waits until the scheduled date and time of the return of the provider vehicle 2S, i.e., the rental end date and time as originally reserved. At the scheduled date and time, in step S231, the server apparatus 1 notifies the user of the return of the provider vehicle 2S.

Then, the server apparatus 1 performs the processing of steps S223 and S224 and step S161 and the subsequent steps of FIG. 9.

As a result, no psychological stress is imposed on the user when the user can rent the charger 53 as reserved regardless of the return of the provider.

### Fourth Processing Example

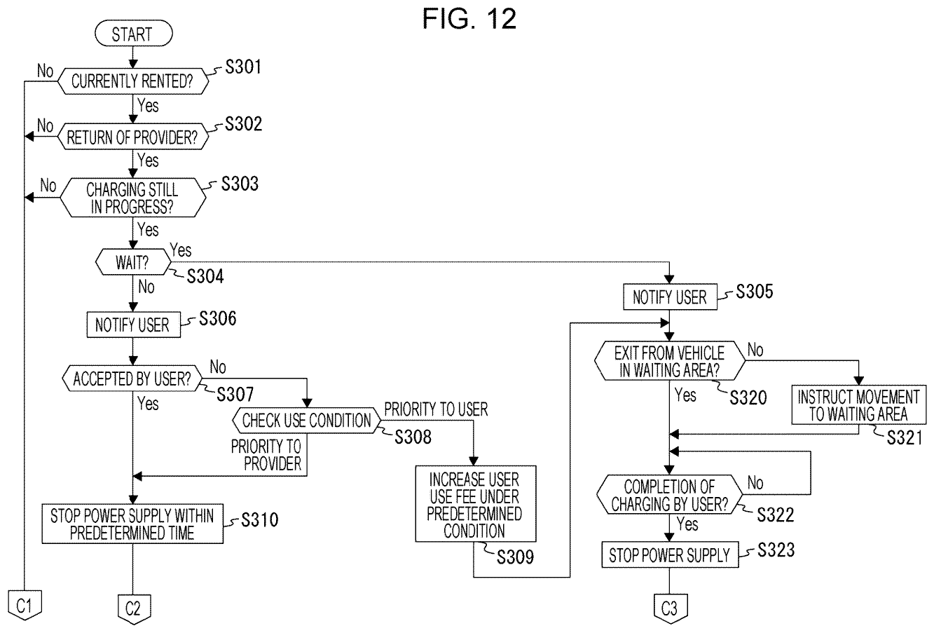

A fourth processing example will be described with reference to FIG. 12. The signs “C1”, “C2”, and “C3” in FIG. 12 lead to FIG. 9.

The fourth processing example is a processing example in consideration of a case where charging by the user is not completed beyond the scheduled date and time. The case where charging is not completed may be, for example, a case where the server apparatus 1 fails to accurately calculate the time taken for the charging and fails to perform reservation setting for an appropriate charging time, a case where the user makes an operation failure, or a case where the incomplete charging is caused by the performance, malfunction, or the like of the charger 53. There is also a case where the user is still away from the user vehicle 2R and does not return beyond the scheduled date and time.

If it is determined in step S301 that the charger 53 is being rented and if it is determined in step S302 that the provider vehicle 2S has returned to the parking space 52, the server apparatus 1 performs the processing of step S303 and the subsequent steps.

In step S303, the server apparatus 1 determines whether charging of the user vehicle 2R is still in progress even after the scheduled date and time of the end of the rental period. If the charging has been completed, the adjustment processing is not performed. Thus, the process of FIGS. 12 and 9 ends. In this case, the term “charging in progress” refers to a state in which the user vehicle 2R has not exited the parking space 52.

If the charging is in progress, in step S304, the server apparatus 1 notifies the provider that the charging is in progress, and determines whether the provider is waiting.

If the provider selects to wait for the completion of charging and operates the provider terminal 51 to transmit a response indicating that the provider is waiting to the server apparatus 1, the server apparatus 1 proceeds from step S304 to step S305, and notifies the user terminal 21 that the provider has returned but is waiting.

Then, in steps S320 and S321, the server apparatus 1 brings the provider vehicle 2S into a waiting state in the waiting area 58. The occupant can exit the provider vehicle 2S and return home.

In step S322, the server apparatus 1 waits for the completion of charging. When the charging is completed, in step S323, the server apparatus 1 instructs the provider terminal 51 to stop the power supply.

Thereafter, the server apparatus 1 performs the processing of step S161 and the subsequent steps of FIG. 9.

If, in step S304, the provider operates the provider terminal 51 and transmits a response indicating a request for the exit of the user vehicle 2R to the server apparatus 1, in step S306, the server apparatus 1 notifies the user terminal 21 of an exit request from the provider. In response to the notification, the user transmits, from the user terminal 21, a response indicating that the user accepts the exit request or makes a use continuation request.

If, in step S307, a response indicating a request to use the charger 53 for an amount of time longer than the scheduled time is received from the user terminal 21, in step S308, the server apparatus 1 checks a use condition. If it is determined that priority is given to the user, in step S309, the server apparatus 1 performs a process of increasing the use fee charged to the user under a predetermined condition, and proceeds to the processing of step S320 and the subsequent steps.

This is because the user still uses the charger 53 beyond the scheduled date and time. However, when the charging is not completed within the scheduled time due to the server apparatus 1 or the charger 53, the use fee is considered not to be increased.

If information indicating acceptance of the exit request is received from the user terminal 21, the server apparatus 1 proceeds from step S307 to step S310. The server apparatus 1 also proceeds to step S310 if it is determined in step S308 that priority is given to the provider. In step S310, the server apparatus 1 instructs the provider terminal 51 to stop the power supply within a predetermined time, and then proceeds to the processing of step S151 and the subsequent steps of FIG. 9.

The above-described process makes it possible to perform adjustment in a case where the charging of the user vehicle 2R is not completed within the scheduled time.

### Effects of Embodiment

According to the embodiment described above, the following effects can be obtained.

The server apparatus 1 according to the embodiment performs a process of instructing the provider vehicle 2S, which is an automatically drivable vehicle, to move to a predetermined waiting area 58 in accordance with an exit of an occupant from the provider vehicle 2S when the provider vehicle 2S is to return to the parking space 52 and the parking space 52 is occupied by the user vehicle 2R (step S104 of FIG. 8, step S222 of FIGS. 10 and 11, and step S321 of FIG. 12). In addition, the server apparatus 1 performs a process of instructing the provider vehicle 2S to move from the waiting area 58 to the parking space 52 in accordance with a detection of an exit of the user vehicle 2R from the parking space 52 (step S163 in FIG. 9). In addition, the server apparatus 1 performs a process of transmitting a return notification to the provider in response to a return of the provider vehicle 2S to the parking space 52 (step S164 in FIG. 9).

When the provider returns earlier than a scheduled date and time or when the user is performing charging or the like even in a case where the provider returns on the scheduled date and time, the provider vehicle 2S cannot enter the parking space 52, but is allowed to wait in a nearby waiting area 58. Thus, the occupant such as the provider can exit the provider vehicle 2S and return home. In response to an exit of the user vehicle 2R from the parking space 52, the provider vehicle 2S autonomously travels and enters the parking space 52. This can prevent the occurrence of inconvenience due to the provider subscribing the charger rental service.

In the embodiment, the return notification in step S164 of FIG. 9 includes information indicating the remaining amount of a rechargeable battery of the provider vehicle 2S.

In response to the provider vehicle 2S autonomously traveling and entering the parking space 52 after the exit of the user vehicle 2R, the provider receives a notification from the provider terminal 51. The remaining charge is presented to the provider, thus allowing the provider to determine the necessity of charging. This ensures that the provider does not forget to charge the provider vehicle 2S in the parking space 52.

The server apparatus 1 according to the embodiment performs a process of transmitting a provider return notification to the user terminal 21 when the provider vehicle 2S is to return to the parking space 52 occupied by the user vehicle 2R (step S111 of FIG. 8, step S205 of FIGS. 10 and 11, and step S306 of FIG. 12). In addition, the server apparatus 1 performs a process of increasing or decreasing a fee to be paid by the user or a profit to be provided to the provider in accordance with a relationship between a date and time of the return of the provider vehicle 2S and a scheduled charging end date and time and in accordance with whether the user vehicle 2R has exited the parking space 52 (steps S114 and S134 in FIG. 8, steps S208 and S309 in FIGS. 10 and 11, and step ST in FIG. 12).

By knowing the return of the provider, the user can determine whether to make the user vehicle 2R exit the parking space 52 or to continue charging the user vehicle 2R.

In this case, the server apparatus 1 adjusts the payment amount of the user and the reward to the provider in consideration of circumstances such as the provider returning earlier than scheduled, the user performing charging beyond the scheduled time, or the user exiting the parking space 52 although charging is not completed. As a result, a fair service can be provided to both of them.

The embodiment presents an example in which the server apparatus 1 transmits the provider return notification after the scheduled charging end date and time when it is selected the provider vehicle 2S waits for completion of charging of the user vehicle 2R (steps S230 and S231 of FIG. 11).

The provider can select to wait for the completion of charging when returning early due to personal convenience. In this case, the provider return notification is not sent to the user until the scheduled date and time of the end of charging (the scheduled date and time of the end of the rental period). Thus, no unnecessary psychological pressure can be imposed on the user.

In the embodiment, in response to a request from the provider for the user vehicle 2R to exit the parking space 52 and a request from the user to continue charging the user vehicle 2R in the parking space 52, the server apparatus 1 determines which of the request from the provider and the request from the user to give priority to in accordance with a use condition (steps S113 and S132 of FIG. 8, step S207 of FIGS. 10 and 11, and step S308 of FIG. 12). Then, the server apparatus 1 executes processing for the exit of the user vehicle 2R or continuation of charging of the user vehicle 2R in accordance with a determination result. For example, the server apparatus 1 executes a process of stopping the power supply within a predetermined time or stopping the power supply after the completion of charging.

When the request from the provider to park the provider vehicle 2S and the request from the user to continue charging are received, the server apparatus 1 determines whether to give priority to the user or the provider in accordance with a use condition or situations, and selects whether to move the provider vehicle 2S to the waiting area 58 or stop charging the user vehicle 2R. As a result, both the user and the provider can be satisfied.

According to an embodiment of the present invention can prevent the occurrence of inconvenience to a provider when the provider returns to a charging spot earlier than a scheduled date and time in a case where the charging spot is installed in a general household or the like, or when a user is performing charging or the like even in a case where the provider returns on the scheduled date and time.

The server apparatus 1 illustrated in FIG. 5 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the registration processor 1a, the reservation setting processor 1b, and the charging/payment manager 1c. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 5.

1. A server apparatus comprising:
one or more processors; and
a storage medium storing a program configured to be executed by the one or more processors, wherein
the program comprises one or more instructions, and
the one or more instructions cause the one or more processors to execute:
instructing a provider vehicle of a provider who provides a user with a charger installed in a parking space designated for use by the provider to move to a predetermined waiting area in accordance with an exit of an occupant from the provider vehicle when the provider vehicle is to return to the parking space and the parking space is occupied by a user vehicle of the user, the provider vehicle being an automatically drivable vehicle;
transmitting a provider return notification to a terminal used by the user when the provider vehicle is to return to the parking space occupied by the user vehicle;
instructing the provider vehicle to move from the waiting area to the parking space in accordance with a detection of an exit of the user vehicle from the parking space;
transmitting a return notification to a terminal used by the provider in response to a return of the provider vehicle to the parking space; and
increasing or decreasing a fee to be paid by the user and/or a profit to be provided to the provider in accordance with a relationship between a date and time of the return of the provider vehicle and a scheduled charging end date and time and in accordance with whether the user vehicle has exited the parking space.

2. The server apparatus according to claim 1, wherein
the return notification includes information indicating a remaining amount of a rechargeable battery of the provider vehicle.

3. The server apparatus according to claim 1, wherein
the provider return notification is transmitted after the scheduled charging end date and time when it is selected that the provider vehicle waits for completion of charging of the user vehicle.

4. The server apparatus according to claim 2, wherein
the provider return notification is transmitted after the scheduled charging end date and time when it is selected that the provider vehicle waits for completion of charging of the user vehicle.

5. A server apparatus comprising:
one or more processors; and
a storage medium storing a program configured to be executed by the one or more processors, wherein
the program comprises one or more instructions, and
the one or more instructions cause the one or more processors to execute:
instructing a provider vehicle of a provider who provides a user with a charger installed in a parking space designated for use by the provider to move to a predetermined waiting area in accordance with an exit of an occupant from the provider vehicle when the provider vehicle is to return to the parking space and the parking space is occupied by a user vehicle of the user, the provider vehicle being an automatically drivable vehicle;
instructing the provider vehicle to move from the waiting area to the parking space in accordance with a detection of an exit of the user vehicle from the parking space;
transmitting a return notification to a terminal used by the provider in response to a return of the provider vehicle to the parking space; and
in response to a request from the provider for the user vehicle to exit the parking space and a request from the user to continue charging the user vehicle in the parking space, performing a determination on which of the request from the provider and the request from the user to give priority to in accordance with a use condition, and executing processing for the exit of the user vehicle or continuation of charging of the user vehicle in accordance with the determination.
